(19) United States
(12) Patent Application Publication
(10) Pub. No.: US 2008/0231721 A1
(43) Pub. Date: Sep. 25, 2008

(54) Image capture systems and methods

(75) Inventors: Fu-Chiang Chou, Taoyuan (TW); John C. Wang, Taoyuan (TW)

Correspondence Address: BIRCH STEWART KOLASCH & BIRCH, PO BOX 747, FALLS CHURCH, VA, 22040-0747, US

(73) Assignee: High Tech Computer Corp.

(21) Appl. No.: 12/010,618

(22) Filed: Jan. 28, 2008

(30) Foreign Application Priority Data
Mar. 20, 2007 (TW) 96109496

(51) Int. Cl. H04N 5/228

(52) U.S. Cl. 348/222.1; 348/E05.031

(57) ABSTRACT

Image capture systems and methods for use in a picture-taking device. The system comprises an image sensor and a processing unit. The image sensor captures at least one picture. The processing unit determines whether a specific behavior exists in the picture. If so, the processing unit drives the device to perform a photography process to take an image via the image sensor.

### BACKGROUND OF THE INVENTION

1. Field of the Invention

The disclosure relates generally to image capture systems and methods, and, more particularly to systems and method that take images via specific behaviors such as gestures or actions.

2. Description of the Related Art

Recently, portable devices, such as handheld devices, have become more and more technically advanced and multifunctional. For example, a handheld device may provide image capturing (picture-taking) capabilities operating like a digital camera, and have built-in self-timing mechanisms. A self-timer is a device on a camera that, when enabled, provides users with a time delay, such as ten seconds, between the pressing of the camera button and the image being captured. One reason for using a self-timer is so that the picture takers can be included in the image. Additionally, self-timers can allow vibrations, which may cause image blur, to dissipate before the image is captured.

However, conventional self-timing mechanisms have some noticeable drawbacks. After pressing the camera button, picture takers are allowed a fixed time, such as ten seconds, to position and compose themselves before the image is captured. Meanwhile, if repeated shots are necessary, another ten seconds will be required for the next image to be captured. The burdensome processes of waiting and repeated shots, may sometimes result in a poorer image outcome by the image subjects, as displeasure to the process is revealed on their faces.

Thus, there is a need for image capturing mechanisms that permit picture takers to position themselves at their own pace, allowing for all of the image subjects to compose themselves adequately, and allow the picture taker to signal readiness to the camera via specific behaviors, at which time the image will be captured.

### BRIEF SUMMARY OF THE INVENTION

Image capture systems and methods are provided.

An embodiment of an image capture system for use in a picture-taking device comprises an image sensor and a processing unit. The image sensor captures at least one picture. The processing unit determines whether a specific behavior exists in the picture. If so, the processing unit drives the device to perform a photography process to take an image via the image sensor.

In an embodiment of an image capture method for use in a picture-taking device, at least one picture is captured. It is determined whether a specific behavior exists in the picture. If so, a photography process is performed to take an image.

Image capture systems and methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an image capture system;

FIG. 2 shows an example of an operating interface; and

FIG. 3 is a flowchart of an embodiment of an image capture method.

### DETAILED DESCRIPTION OF THE INVENTION

Image capture systems and methods are provided.

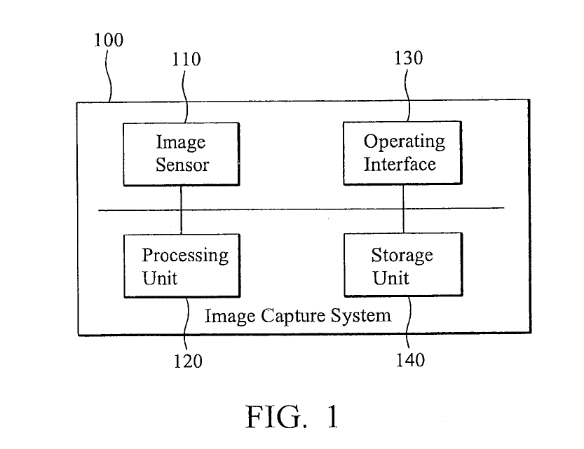

FIG. 1 is a schematic diagram illustrating an embodiment of an image capture system.

The image capture system 100 can be used in devices having image capture capability, such as digital cameras, or picture-taking handheld devices such as mobile phones, smart phones, PDAs (Personal Digital Assistants), and GPSs (Global Positioning Systems). The image capture system 100 comprises an image sensor 110, a processing unit 120, an operating interface 130, and a storage unit 140. The image sensor 110 may be a CCD (Charge Coupled Device) or a CMOS (Complementary Metal-Oxide Semiconductor), placed at the imaging position for objects inside the device.

The processing unit 120 controls related components of the image capture system 100, processes the pictures captured by the image sensor 110, and performs the image capture methods. A more detailed description of the image capture methods is discussed later. It is understood that, the image capture system 100 further comprises a focus unit (not shown in FIG. 1). The processing unit 120 controls the focus unit to perform a focus process for at least one object during a photography process. The data captured by the image sensor 110 can be permanently or temporarily stored in the storage unit 140. The storage unit 140 may be a built-in memory, or an external memory card.

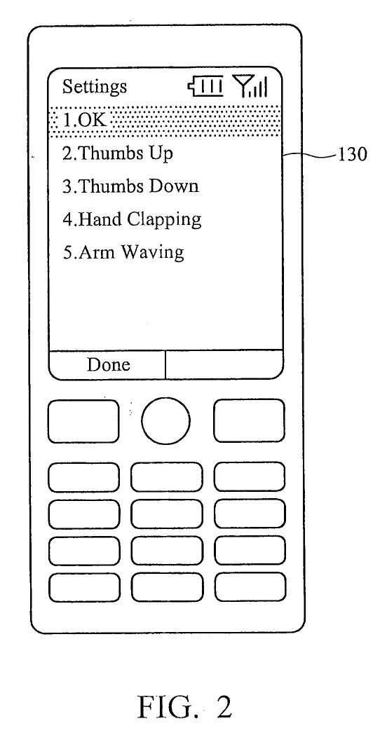

The operating interface 130 allows users to perform related settings. For example, users can set a specific behavior such as a gesture or an action, enabling the image capture system 100 to perform a photography process. FIG. 2 shows an example of an operating interface. In this example, the operating interface 130 provides a menu. The menu comprises several specific behaviors such as gestures of “OK”, thumbs up or thumbs down, or actions such as hand clapping or arm waving. Users can select one of the specific behaviors to be the instruction directing the image capture system 100 to perform a photography process. Additionally, users can set a specific time (not shown in FIG. 2) via the operating interface 130. The specific time is the time between the pressing of the camera button and an image being captured.

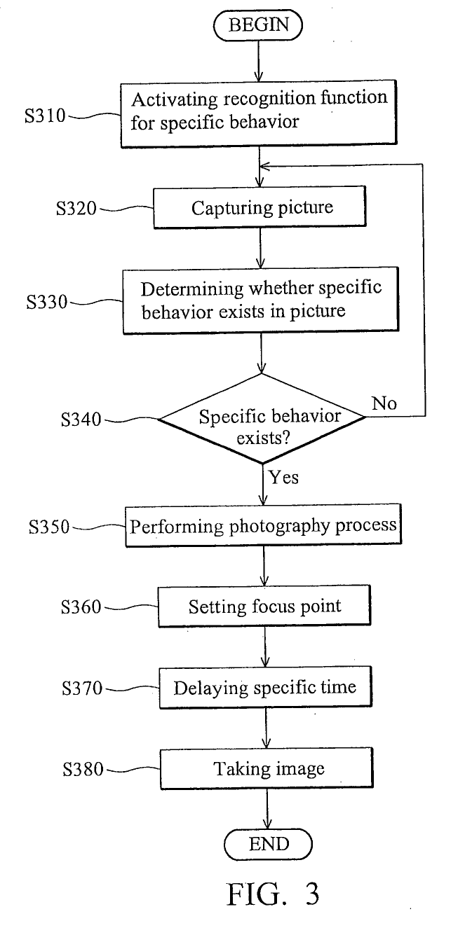

FIG. 3 is a flowchart of an embodiment of an image capture method.

When users want to perform image capture using a specific behavior, in step S310, a recognition function for specific behavior is activated. It is understood that the image capture system 100 may provide a selection for activating the recognition function. In step S320, the image sensor 110 continuously captures pictures. In step S330, it is determined whether a predefined specific behavior such as a specific gesture or a specific action exists in the captured pictures. It is noted that an object recognition algorithm can be used to determine whether at least one hand (or a hand-like object) exists in a picture, and determine whether the hand gesture conforms to the specific gesture. Additionally, an object tracking algorithm can be used to determine whether at least one specific object such as hand or arm exists in several pictures, and determine whether the moving of the specific object conforms to the predefined specific action. If the predefined specific behavior is not in the picture (No in step S340), the procedure returns to step S320. If the predefined specific behavior exists in the picture (Yes in step S340), representing an instruction directing the image capture system 100 to perform a photography process, in step S350, the photography process is performed. In step S360, a focus point required in the photography process is set. It is understood that, in some embodiments, the focus point can be detected via the focus unit, or set as the position where the specific behavior is recognized. In step S370, a specific time is delayed, and in step S380, an image is taken according to the focus point. It is noted that, in addition to the focus process, related exposure and compensation calculations are also required during the photography process. Any focus, exposure and compensation processes can be used in the embodiments of the invention.

Image capture systems and methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image capture system for use in a picture-taking device, comprising:
an image sensor capturing at least one picture; and
a processing unit determining whether a specific behavior exists in the picture, and if so, driving the device to perform a photography process to take an image via the image sensor.

2. The system of claim 1 wherein the specific behavior comprises a specific gesture or a specific action.

3. The system of claim 2 wherein the processing unit uses an object recognition algorithm to determine whether at least one hand is in the picture, and determine whether a gesture of the hand conforms to the specific gesture.

4. The system of claim 2 wherein the processing unit uses an object tracking algorithm to determine whether at least one specific object is in the picture, and determine whether a movement of the specific object conforms to the specific action.

5. The system of claim 1 further comprising an operating interface for setting the specific behavior.

6. The system of claim 1 wherein after the specific behavior is determined in the picture, the processing unit further delays a specific time, and performs the photography process to take the image via the image sensor after the specific time passes.

7. The system of claim 6 further comprising an operating interface for setting the specific time.

8. The system of claim 1 wherein the processing unit further detects a focus point during the photography process, and takes the image accordingly.

9. The system of claim 1 wherein the processing unit further sets a position corresponding to the specific behavior as a focus point, and takes the image accordingly.

10. An image capture method for use in a picture-taking device, comprising:
capturing at least one picture;
determining whether a specific behavior exists in the picture; and
if so, perform a photography process to take an image.

11. The method of claim 10 wherein the specific behavior comprises a specific gesture or a specific action.

12. The method of claim 11 further comprising:
determining whether at least one hand is in the picture using an object recognition algorithm; and
determining whether a gesture of the hand conforms to the specific gesture.

13. The method of claim 11 further comprising:
determining whether at least one specific object is in the picture using an object tracking algorithm; and
determining whether a movement of the specific object conforms to the specific action.

14. The method of claim 10 further comprising setting the specific behavior via an operating interface.

15. The method of claim 10 further comprising:
when the specific behavior is determined in the picture, delaying a specific time; and
performing the photography process to take the image after the specific time passes.

16. The method of claim 15 further comprising setting the specific time via an operating interface.

17. The method of claim 10 further comprising:
detecting a focus point during the photography process; and
taking the image accordingly.

18. The method of claim 10 further comprising:
setting a position corresponding to the specific behavior as a focus point; and
taking the image accordingly.

19. A machine-readable storage medium comprising a computer program, which, when executed, causes a device to perform an image capture method, the method comprising:
capturing at least one picture;
determining whether a specific behavior exists in the picture; and
if so, performing a photography process to take an image.

20. The storage medium of claim 19 wherein the method further comprises:
when the specific behavior is determined in the picture, delaying a specific time; and
performing the photography process to take the image after the specific time passes.
